(19) United States
(12) Patent Application Publication
(10) Pub. No.: US 2024/0412177 A1
(43) Pub. Date: Dec. 12, 2024

(54) APPARATUSES, COMPUTER-IMPLEMENTED METHODS, AND COMPUTER PROGRAM PRODUCTS FOR FINANCIAL TRANSACTIONS

(71) Applicant: Wells Fargo Bank, N.A., San Francisco, CA (US)

(72) Inventor: Jeffrey Taylor Kell, San Francisco, CA (US)

(21) Appl. No.: 17/141,471

(22) Filed: Jan. 5, 2021

(51) Int. Cl. G06Q 20/10; G06F 16/2455

(52) U.S. Cl. CPC G06Q 20/10; G06F 16/2455

(57) ABSTRACT

Computer-implemented methods, systems, apparatuses, and computer program products are disclosed for financial transactions. An example method includes generating a user interface for presentation to a first user associated with a first user account and accessing first user financial data associated with the first user and the first user account. The method further includes generating one or more interrogatory objects requesting responsive inputs from the first user based upon the first user financial data and presenting the one or interrogatory objects to the first user in the user interface. The method also includes arranging a financial transaction based upon the first user financial data and one or more responsive inputs by the first user to the interrogatory objects. In response to authorization by the first user, the method further includes executing the financial transaction within the user interface.

### TECHNOLOGICAL FIELD

Example embodiments of the present disclosure relate generally to financial transactions and, more particularly, to the arrangement and execution of financial transactions via user interfaces.

### BACKGROUND

Account owners and other users may interact with entities, such as a financial institution associated with their account, to request assistance with various questions, transactions, and/or the like. In some instances, users may interact with these entities via a user interface that may be actively managed by a human operator or may be, in whole or in part, supported by an automated system. In some instances, such a user interface may be used to direct a user to various separate locations, webpages, applications, or the like that provide additional information relevant to the user's question(s).

### BRIEF SUMMARY

As described above, businesses, financial institutions, merchants, venders, service providers, and other entities may employ user interfaces with which a user may interact. Such user interfaces may be implemented as a live chat in which messages may be exchanged between a user and an operator, human or automated, of the user interface. By way of example, a user may enter a textual input into a live chat requesting assistance with an issue, transaction, feature offered by the associated entity, and/or the like. In many instances, however, the operator (e.g., human or automated) lacks the necessary information concerning the user to provide relevant information. Furthermore, traditional user interfaces often fail to provide responsive actions to a user's request, instead operating to redirect the user's request to another service, application, location, website, or the like. In the context of financial transactions, these deficiencies of conventional systems are further amplified by the integral nature of the user's financial information in completing transactions. Said differently, the inability of conventional systems to properly access and leverage user financial data results in the failure of these systems to arrange and execute financial transactions within, for example, a user interface. Furthermore, current user interfaces operate reactive to user inputs (e.g., a user's request for a financial transaction) and, as such, fail to anticipate the financial needs of users that would otherwise be gleaned from the financial data associated with a user. Said differently, traditional reactive systems fail to proactively identify, and remedy financial deficiencies associated with a user.

To solve these issues and others, example implementations of embodiments of the present disclosure may access financial data of a user during interaction with a user interface so as to arrange and execute financial transactions within the user interface. In operation, embodiments of the present disclosure may generate a user interface that may receive user inputs and access financial data associated with a user and associated user account. In order to obtain information regarding the user's intent or request, the disclosed systems may generate interrogatory objects that request responsive inputs from the user and arrange a financial transaction based upon the financial data and responsive inputs of the user. By accessing financial information of a user and, in some embodiments, being formed as part of a system of a financial institution, the systems described herein may execute an authorized financial transaction within the user interface. In this way, the inventor has identified that the advent of new computing technologies have created a new opportunity for solutions for executing financial transactions which were historically unavailable. In doing so, such example implementations confront and solve at least two technical challenges: (1) they generate remedies for user-specific financial deficiencies in real-time, and (2) they minimize processing and computational burdens associated with financial transaction systems.

As such, apparatuses, computer-implemented methods, and computer program products are provided for financial transactions. With reference to an example computer-implemented method, the example method may include generating a user interface for presentation to a first user associated with a first user account, the user interface configured to receive one or more user inputs and accessing first user financial data associated with the first user and the first user account. The method may further include generating one or more interrogatory objects requesting responsive inputs from the first user based upon the first user financial data and presenting the one or interrogatory objects to the first user in the user interface. The method may further include arranging a financial transaction based upon the first user financial data and one or more responsive inputs by the first user to the interrogatory objects and, in response to authorization by the first user, executing the financial transaction within the user interface.

In some embodiments, accessing the first user financial data may include receiving a user input requesting the financial transaction and accessing the first user financial data in response to the user input.

In some embodiments, the one or more interrogatory objects may also include one or more recommended responsive inputs based upon the first user financial data.

In some embodiments, accessing the first user financial data further includes querying a financial data database comprising financial data associated with respective users upon generation of the user interface.

In some further embodiments, the method may include determining at least one instance in which the first user financial data is indicative of a deficiency associated with the first user account, wherein the one or more interrogatory objects further include project data associated with one or more tasks for completion.

In some further embodiments, in an instance in which the responsive input by the first user selects an interrogatory object comprising project data, the method may include arranging the financial transaction by funding, via a second user account, an escrow account based upon the project data.

In some still further embodiments, executing the financial transaction within the user interface may further include dispersing the funds of the escrow account to the first user account in an instance in which the one or more tasks associated with the project data are complete.

The above summary is provided merely for purposes of summarizing some example embodiments to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which will be further described below.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIG. 1 illustrates a system diagram including devices that may be involved in some example embodiments described herein.

FIG. 2 illustrates a schematic block diagram of example circuitry that may perform various operations, in accordance with some example embodiments described herein.

FIG. 3 illustrates an example flowchart for executing financial transactions via a user interface, in accordance with some example embodiments described herein.

FIGS. 4A-4H illustrate an example user interface during performance of the operations of FIG. 3, in accordance with some example embodiments described herein.

FIG. 5 illustrates an example flowchart for task-related escrow disbursement, in accordance with some example embodiments described herein.

FIGS. 6A-6E illustrate an example user interface during performance of the operations of FIG. 5, in accordance with some example embodiments described herein.

### DETAILED DESCRIPTION

Some embodiments of the present disclosure will now be described more fully hereinafter with reference to the accompanying drawings, in which some, but not all embodiments are shown. Indeed, the disclosure may be embodied in many different forms and should not be construed as limited to the embodiments set forth herein; rather, these embodiments are provided so that this disclosure will satisfy applicable legal requirements. Like numbers refer to like elements throughout. As used herein, the description may refer to an transaction server as an example “apparatus.” However, elements of the apparatus described herein may be equally applicable to the claimed method and computer program product. Thus, use of any such terms should not be taken to limit the spirit and scope of embodiments of the present disclosure.

### Definition of Terms

As used herein, the terms “data,” “content,” “information,” “electronic information,” “signal,” “command,” and similar terms may be used interchangeably to refer to data capable of being transmitted, received, and/or stored in accordance with embodiments of the present disclosure. Thus, use of any such terms should not be taken to limit the spirit or scope of embodiments of the present disclosure. Further, where a first computing device is described herein to receive data from a second computing device, it will be appreciated that the data may be received directly from the second computing device or may be received indirectly via one or more intermediary computing devices, such as, for example, one or more servers, relays, routers, network access points, base stations, hosts, and/or the like, sometimes referred to herein as a “network.” Similarly, where a first computing device is described herein as sending data to a second computing device, it will be appreciated that the data may be sent directly to the second computing device or may be sent indirectly via one or more intermediary computing devices, such as, for example, one or more servers, remote servers, cloud-based servers (e.g., cloud utilities), relays, routers, network access points, base stations, hosts, and/or the like.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

As used herein, the phrases “in one embodiment,” “according to one embodiment,” “in some embodiments,” and the like generally refer to the fact that the particular feature, structure, or characteristic following the phrase may be included in at least one embodiment of the present disclosure. Thus, the particular feature, structure, or characteristic may be included in more than one embodiment of the present disclosure such that these phrases do not necessarily refer to the same embodiment.

As used herein, the word “example” is used to mean “serving as an example, instance, or illustration.” Any implementation described herein as “example” is not necessarily to be construed as preferred or advantageous over other implementations.

As used herein, the terms “user interface,” “interface,” and the like refer to a collection of dynamic elements configured to receive user inputs and/or display data. By way of example, a mobile device or user device (e.g., a smartphone, a tablet computer, a laptop computer, a wearable device, smart glasses, smart watch, or the like) that is equipped with a chip or other electronic device that is configured to communicate with the apparatus via Bluetooth, NFC, Wi-Fi, 3G, 4G, 5G, RFID protocols, and the like may display a user interface as described hereafter. Such a user interface may be, for example, interacted with by a user in that the user interface may receive user inputs (e.g., text inputs, voice inputs, tactile inputs, and/or the like). By way of a particular example, a user may, in response to an interrogatory object, receive responsive user inputs. The user interface may further include functionality of or otherwise be configured to interact with a keyboard, a mouse, a joystick, a touch screen, touch areas, soft keys, a microphone, a scanner, speaker, or other input/output mechanisms. Although described herein with reference to a user interface generated and rendered by, for example, a user device associated with the user, the present disclosure contemplates that the user interface may further be generated and rendered via virtual reality (VR) and/or augmented reality (AR) technologies. For example, the user interface may include a user simulation or simulated experience in which a user's physical presence is provided in a virtual environment. Such a virtual environment may include any number of artificial items, features, or the like with which the user may interact. Similarly, the user interface may include an AR or interactive experience with enhanced objects in a real-world environment. Said differently, AR may combine real and virtual worlds or items and, in some instances, may operate as an overlay of a user's real environment.

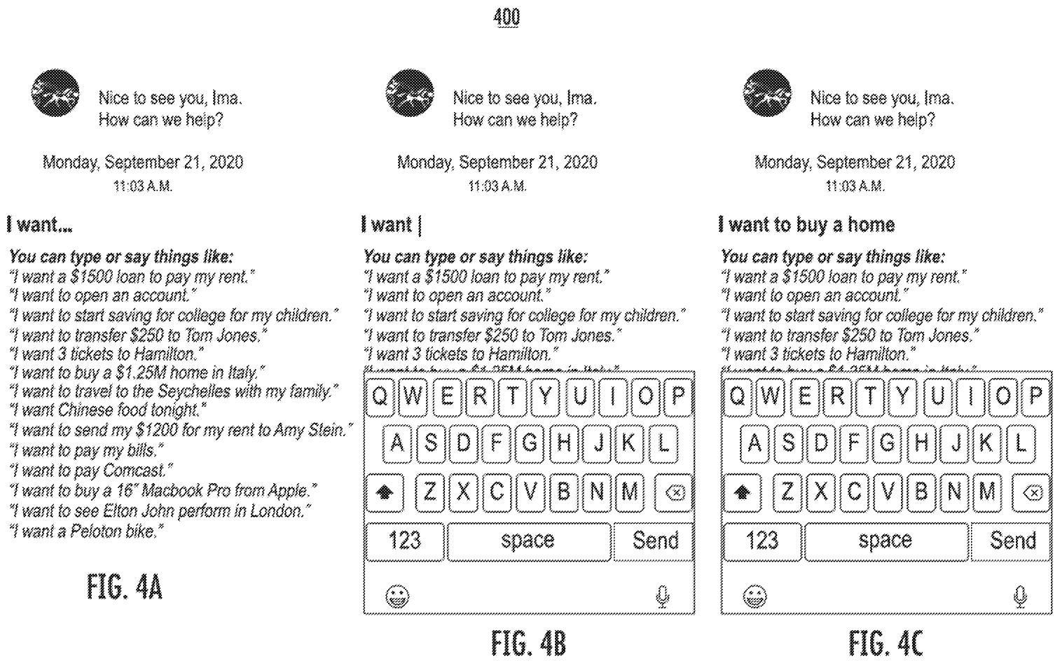

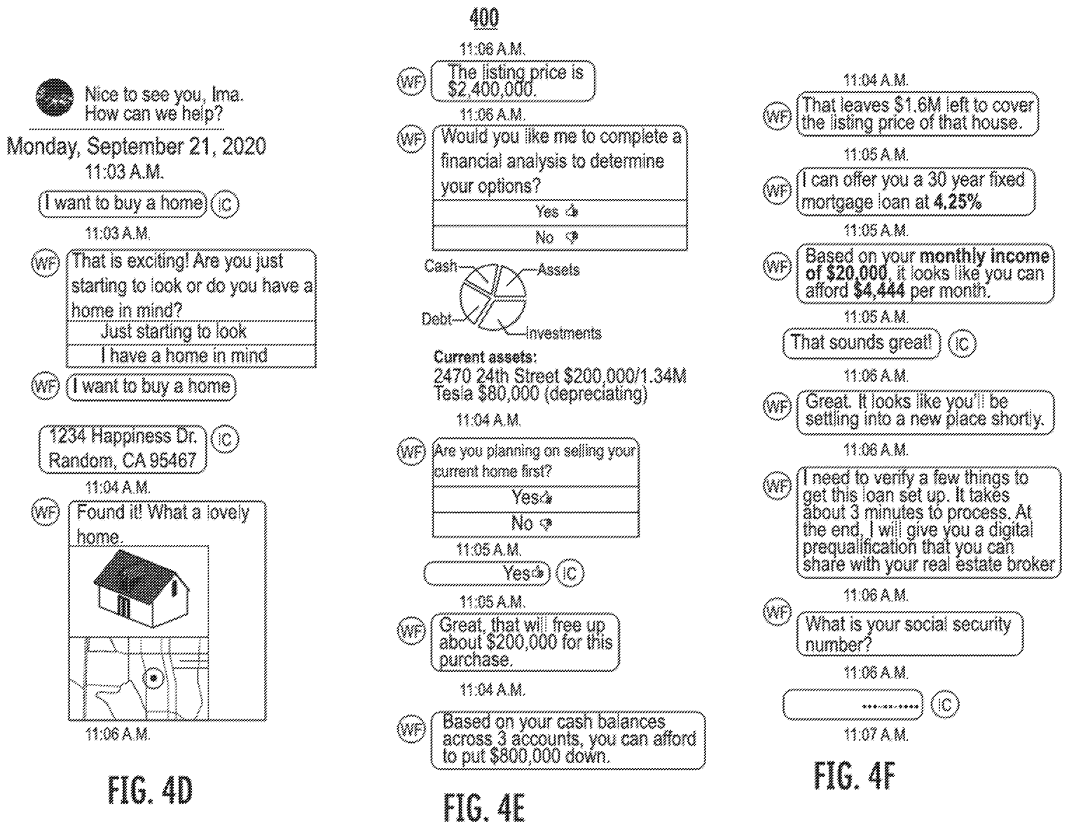

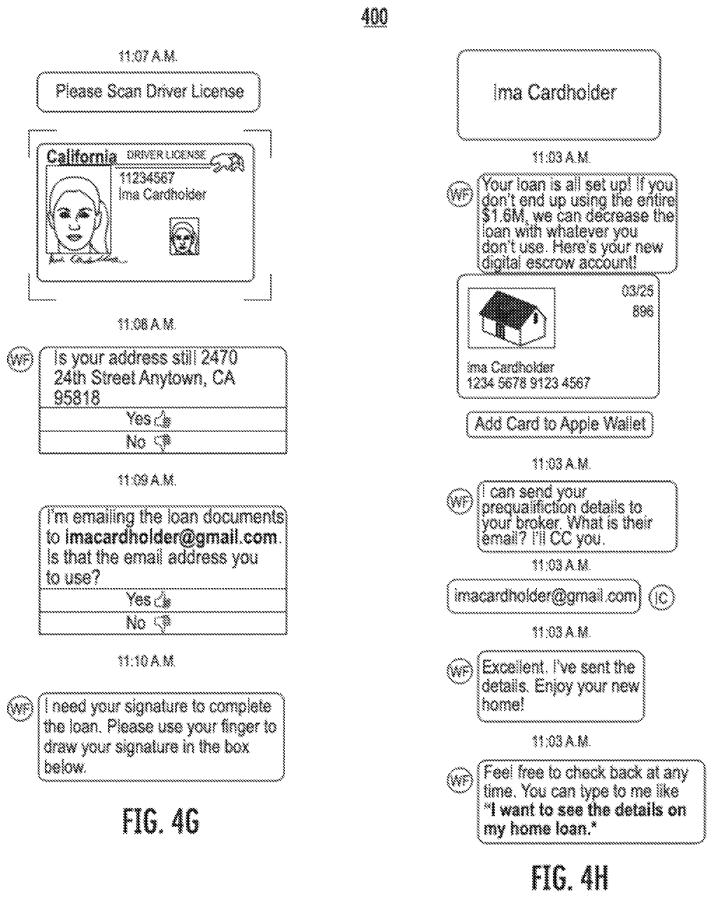

As used herein, the term “interrogatory objects” may refer to objects that may be presented to a user via a user interface and may be configured to receive or otherwise prompt a user response. By way of example, one or more interrogatory objects may be formed as questions requesting particular information of a user and may, in some embodiments, be presented to the user as an open question (e.g., prompting an open text field response). By way of a particular example, an interrogatory object generated for receiving financial data associated with a particular user's identification may be formed, as shown in FIG. 4G, to request a user's input of his or her driver's license or equivalent identification card. In other instances, interrogatory objects may be formed as statements or questions requesting confirmation (e.g., a leading question or otherwise). For example, an interrogatory object may be formed as a statement of a user's account balance, as shown in FIG. 4F, to which a user may respond to confirm the information presented by the interrogatory object. Interrogatory objects of the present disclosure may further be based upon financial data of a user and may, in some embodiments, comprise project data associated with one or more tasks for completion.

As used herein, the term “user financial data” may refer to a collection of settings, configurations, identifiers, data, and information associated with a user and associated user device. User financial data configured in accordance with the present disclosure may be stored by an associated user device, user profile, or the like and may be accessible by one or more of the software applications that are supported by the transaction server and, thus, may include application-specific preferences, settings, configurations, data, and information. In some example embodiments, user financial data of a first user may include account information, preferences, transaction information, account balances, prior transaction histories, investment portfolio data, regular deposit information, and/or the like associated with the first user as described hereafter.

As used herein, the term “computer-readable medium” refers to non-transitory storage hardware, non-transitory storage device or non-transitory computer system memory that may be accessed by a controller, a microcontroller, a computational system or a module of a computational system to encode thereon computer-executable instructions or software programs. A non-transitory “computer-readable medium” may be accessed by a computational system or a module of a computational system to retrieve and/or execute the computer-executable instructions or software programs encoded on the medium. Exemplary non-transitory computer-readable media may include, but are not limited to, one or more types of hardware memory, non-transitory tangible media (for example, one or more magnetic storage disks, one or more optical disks, one or more USB flash drives), computer system memory or random access memory (such as, DRAM, SRAM, EDO RAM), and the like.

Having set forth a series of definitions called-upon throughout this application, an example system architecture and example apparatus is described below for implementing example embodiments and features of the present disclosure.

### Device Architecture and Example Apparatus

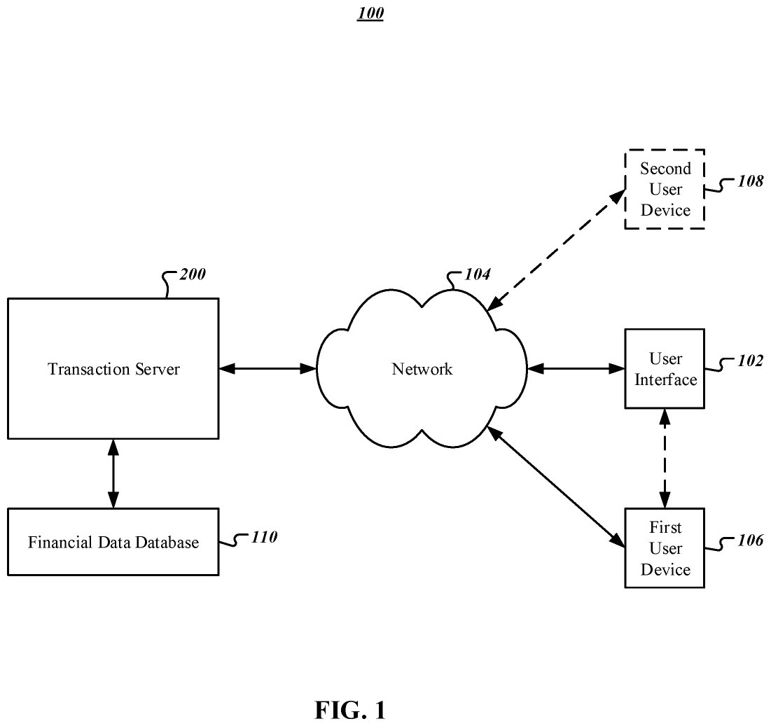

With reference to FIG. 1, an example system 100 is illustrated with an apparatus (e.g., an transaction server 200) communicably connected via a network 104 to user interface 102 and, in some embodiments, a first user device 106 and a second user device 108. The example system 100 may also include a financial data database 110 that may be hosted by the transaction server 200 or otherwise hosted by devices in communication with the transaction server 200.

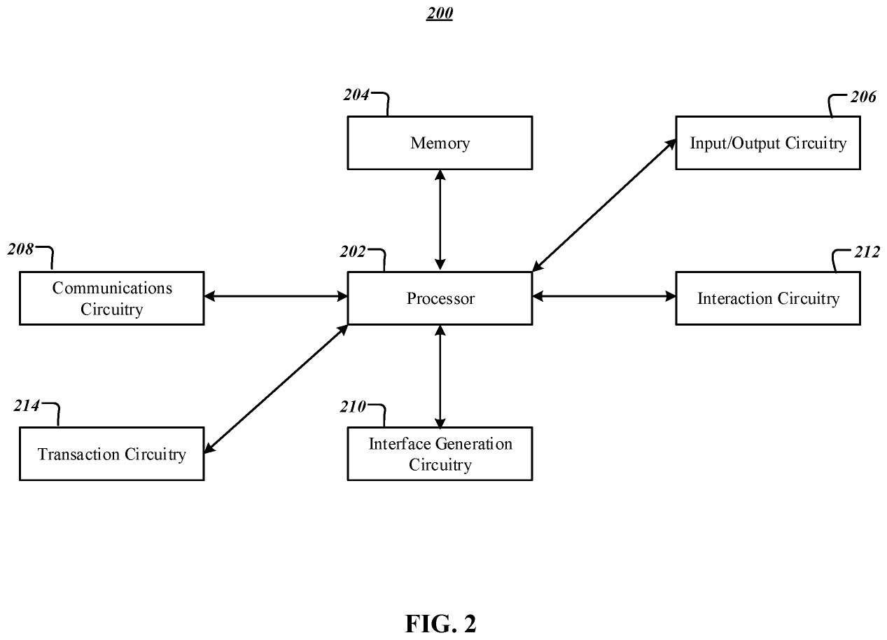

The transaction server 200 may include circuitry, networked processors, or the like configured to perform some or all of the apparatus-based (e.g., transaction server-based) processes described herein, and may be any suitable network server and/or other type of processing device. In this regard, transaction server 200 may be embodied by any of a variety of devices. For example, the transaction server 200 may be configured to receive/transmit data and may include any of a variety of fixed terminals, such as a server, desktop, or kiosk, or it may comprise any of a variety of mobile terminals, such as a portable digital assistant (PDA), mobile telephone, smartphone, laptop computer, tablet computer, or in some embodiments, a peripheral device that connects to one or more fixed or mobile terminals. Example embodiments contemplated herein may have various form factors and designs but will nevertheless include at least the components illustrated in FIG. 2 and described in connection therewith. In some embodiments, the transaction server 200 may be located remotely from the user interface 102, the first user device 106, the second user device 108, and/or financial data database 110, although in other embodiments, the transaction server 200 may comprise the first user device 106, the second user device 108, and/or the financial data database 110 and may be configured to display the user interface 102. The transaction server 200 may, in some embodiments, comprise several servers or computing devices performing interconnected and/or distributed functions. Despite the many arrangements contemplated herein, the transaction server 200 is shown and described herein as a single computing device to avoid unnecessarily overcomplicating the disclosure.

The network 104 may include one or more wired and/or wireless communication networks including, for example, a wired or wireless local area network (LAN), personal area network (PAN), metropolitan area network (MAN), wide area network (WAN), or the like, as well as any hardware, software and/or firmware for implementing the one or more networks (e.g., network routers, switches, hubs, etc.). For example, the network 104 may include a cellular telephone, mobile broadband, long term evolution (LTE), GSM/EDGE, UMTS/HSPA, IEEE 802.11, IEEE 802.16, IEEE 802.20, Wi-Fi, dial-up, and/or WiMAX network. Furthermore, the network 104 may include a public network, such as the Internet, a private network, such as an intranet, or combinations thereof, and may utilize a variety of networking protocols now available or later developed including, but not limited to TCP/IP based networking protocols.

The first user device 106 may refer to a user device associated with a first user and may be a cellular telephone (e.g., a smartphone and/or other type of mobile telephone), laptop, tablet, electronic reader, e-book device, media device, wearable, smart glasses, smartwatch, or any combination of the above. The first user device 106 may be configured to communicate with the transaction server 200 via the network 104. In some embodiments, the first user device 106 may be configured to display, in whole or in part, the user interface 102. Although illustrated in FIG. 1 as a single first user device 106, the present disclosure contemplates that the transaction server 200 may be in network communication (e.g., wired or wireless) with any number of first user devices.

The second user device 108 may refer to a user device associated with a second user and may be a cellular telephone (e.g., a smartphone and/or other type of mobile telephone), laptop, tablet, electronic reader, e-book device, media device, wearable, smart glasses, smartwatch, or any combination of the above. The second user device 108 may be configured to communicate with the transaction server 200 via the network 104. In some embodiments, the second user device 108 may be configured to fund an escrow account based upon project data as described herein. Although illustrated in FIG. 1 as a single second user device 108, the present disclosure contemplates that the transaction server 200 may be in network communication (e.g., wired or wireless) with any number of user devices and associated users. In some embodiments, the second user device 108 may be associated with a vendor, merchant, broker, or other 3rd party system, device, or service. By way of example, as part of generating a user interface for presentation to a first user as described hereafter, the transaction server 200 may receive data from the second user device 108 and render, in whole or in part, a portion of the data received from the second user device 108 as the user interface.

The financial data database 110 may be stored by any suitable storage device configured to store some or all of the information described herein (e.g., memory 204 of the transaction server 200 or a separate memory system separate from the transaction server 200, such as one or more database systems, backend data servers, network databases, cloud storage devices, or the like provided by another device (e.g., online application or 3rd party provider) or the first user device 106). The financial data database 110 may comprise data received from the transaction server 200 (e.g., via a memory 204 and/or processor(s) 202), the first user device 106, the second user device 108, and the corresponding storage device may thus store this data.

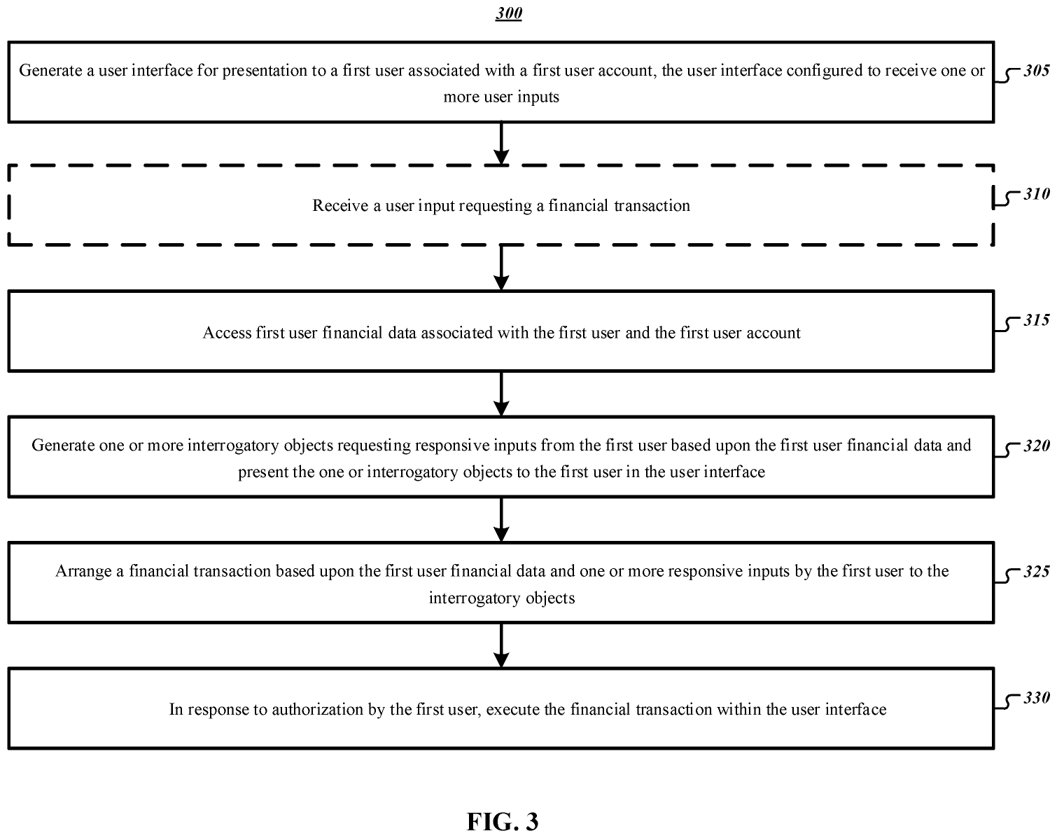

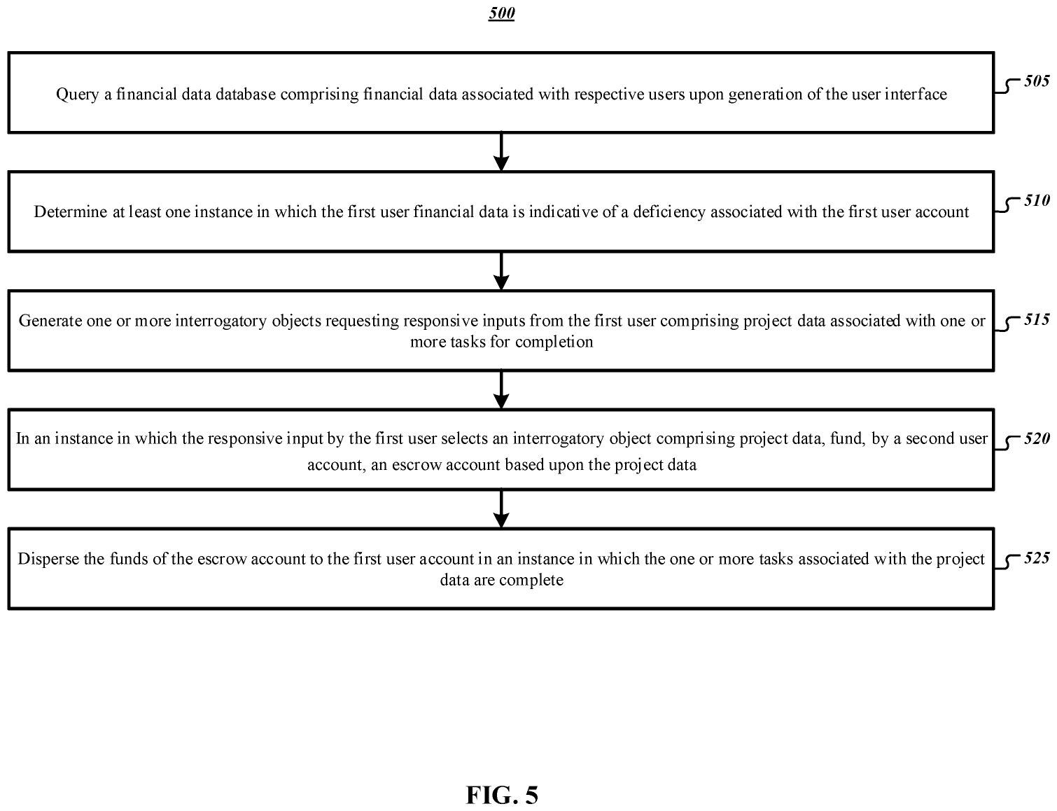

As illustrated in FIG. 2, the transaction server 200 may include a processor 202, a memory 204, communications circuitry 208, and input/output circuitry 206. Moreover, the transaction server 200 may include interface generation circuitry 210, interaction circuitry 212, and/or transaction circuitry 214. The transaction server 200 may be configured to execute the operations described below in connection with FIGS. 3 and 5. Although components 202-214 are described in some cases using functional language, it should be understood that the particular implementations necessarily include the use of particular hardware. It should also be understood that certain of these components 202-214 may include similar or common hardware. For example, two sets of circuitry may both leverage use of the same processor 202, memory 204, communications circuitry 208, or the like to perform their associated functions, such that duplicate hardware is not required for each set of circuitry. The use of the term “circuitry” as used herein includes particular hardware configured to perform the functions associated with respective circuitry described herein. As described in the example above, in some embodiments, various elements or components of the circuitry of the transaction server 200 may be housed within the first user device 106. It will be understood in this regard that some of the components described in connection with the transaction server 200 may be housed within one of these devices, while other components are housed within another of these devices, or by yet another device not expressly illustrated in FIG. 1.

Of course, while the term “circuitry” should be understood broadly to include hardware, in some embodiments, the term “circuitry” may also include software for configuring the hardware. For example, although “circuitry” may include processing circuitry, storage media, network interfaces, input/output devices, and the like, other elements of the transaction server 200 may provide or supplement the functionality of particular circuitry.

In some embodiments, the processor 202 (and/or co-processor or any other processing circuitry assisting or otherwise associated with the processor) may be in communication with the memory 204 via a bus for passing information among components of the transaction server 200. The memory 204 may be non-transitory and may include, for example, one or more volatile and/or non-volatile memories. In other words, for example, the memory may be an electronic storage device (e.g., a non-transitory computer readable storage medium). The memory 204 may be configured to store information, data, content, applications, instructions, or the like, for enabling the transaction server 200 to carry out various functions in accordance with example embodiments of the present disclosure.

The processor 202 may be embodied in a number of different ways and may, for example, include one or more processing devices configured to perform independently. Additionally, or alternatively, the processor may include one or more processors configured in tandem via a bus to enable independent execution of instructions, pipelining, and/or multithreading. The use of the term “processing circuitry” may be understood to include a single core processor, a multi-core processor, multiple processors internal to the transaction server, and/or remote or “cloud” processors.

In an example embodiment, the processor 202 may be configured to execute instructions stored in the memory 204 or otherwise accessible to the processor 202. Alternatively, or additionally, the processor 202 may be configured to execute hard-coded functionality. As such, whether configured by hardware or by a combination of hardware with software, the processor 202 may represent an entity (e.g., physically embodied in circuitry) capable of performing operations according to an embodiment of the present disclosure while configured accordingly. Alternatively, as another example, when the processor 202 is embodied as an executor of software instructions, the instructions may specifically configure the processor 202 to perform the algorithms and/or operations described herein when the instructions are executed.

The transaction server 200 further includes input/output circuitry 206 that may, in turn, be in communication with processor 202 to provide output to a user and to receive input from a user, user device, or another source. In this regard, the input/output circuitry 206 may comprise a display that may be manipulated by a mobile application and may, in some embodiments, display the user interface 102. In some embodiments, the input/output circuitry 206 may also include additional functionality such as a keyboard, a mouse, a joystick, a touch screen, touch areas, soft keys, a microphone, a scanner, speaker, or other input/output mechanisms. The processor 202 may be configured to control one or more functions of a display through computer program instructions (e.g., software and/or firmware) stored on a memory accessible to the processor (e.g., memory 204, and/or the like).

The communications circuitry 208 may be any means such as a device or circuitry embodied in either hardware or a combination of hardware and software that is configured to receive and/or transmit data from/to a network and/or any other device, circuitry, or module in communication with the transaction server 200. In this regard, the communications circuitry 208 may include, for example, a network interface for enabling communications with a wired or wireless communication network. For example, the communications circuitry 208 may include one or more network interface cards, antennae, buses, switches, routers, modems, and supporting hardware and/or software, or any other device suitable for enabling communications via a network. Additionally, or alternatively, the communication interface may include the circuitry for interacting with the antenna(s) to cause transmission of signals via the antenna(s) or to handle receipt of signals received via the antenna(s). These signals may be transmitted by the transaction server 200 using any of a number of wireless personal area network (PAN) technologies, such as Bluetooth® v1.0 through v3.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols.

The interface generation circuitry 210 includes hardware components designed to generate a user interface 102 for presentation to a user and configured to receive user inputs. The interface generation circuitry 210 may utilize processing circuitry, such as the processor 202, to perform its corresponding operations, and may utilize memory 204 to store collected information.

The interaction circuitry 212 includes hardware components designed to access user financial data and generate interrogatory objects requesting responsive inputs from a user based upon the user financial data. The interaction circuitry 212 may further present the one or more interrogatory objects to the first user via the user interface. In some embodiments, the interaction circuitry 212 may further be configured to determine instances of deficiencies associated with a user account. The interaction circuitry 212 may utilize processing circuitry, such as the processor 202, to perform its corresponding operations, and may utilize memory 204 to store collected information.

The transaction circuitry 214 includes hardware components designed to arrange a financial transaction based upon the first user financial data and one or more responsive inputs by the first user to the interrogatory objects. The transaction circuitry 214 may further, in response to authorization by the first user, execute the financial transaction within the user interface. The transaction circuitry 214 may utilize processing circuitry, such as the processor 202, to perform its corresponding operations, and may utilize memory 204 to store collected information.

It should also be appreciated that, in some embodiments, the interface generation circuitry 210, the interaction circuitry 212, and/or the transaction circuitry 214 may include a separate processor, specially configured field programmable gate array (FPGA), or application specific interface circuit (ASIC) to perform its corresponding functions.

In addition, computer program instructions and/or other type of code may be loaded onto a computer, processor or other programmable transaction server's circuitry to produce a machine, such that the computer, processor other programmable circuitry that execute the code on the machine create the means for implementing the various functions, including those described in connection with the components of transaction server 200.

As described above and as will be appreciated based on this disclosure, embodiments of the present disclosure may be configured as systems, methods, mobile devices, and the like. Accordingly, embodiments may comprise various means including entirely of hardware or any combination of software with hardware. Furthermore, embodiments may take the form of a computer program product comprising instructions stored on at least one non-transitory computer-readable storage medium (e.g., computer software stored on a hardware device). Any suitable computer-readable storage medium may be utilized including non-transitory hard disks, CD-ROMs, flash memory, optical storage devices, or magnetic storage devices.

### Example Operations for Executing Financial Transactions Via a User Interface

FIG. 3 illustrates a flowchart containing a series of operations for executing financial transactions via a user interface. The operations illustrated in FIG. 3 may, for example, be performed by, with the assistance of, and/or under the control of an apparatus (e.g., transaction server 200), as described above. In this regard, performance of the operations may invoke one or more of processor 202, memory 204, input/output circuitry 206, communications circuitry 208, interface generation circuitry 210, interaction circuitry 212, and/or transaction circuitry 214.

As shown in operation 305, the apparatus (e.g., transaction server 200) includes means, such as input/output circuitry 206, communications circuitry 208, interface generation circuitry 210, or the like, for generating a user interface 102 for presentation to a first user associated with a first user account. As defined above, the user interface 102 generated by the interface generation circuitry 212 may refer to a collection of dynamic elements configured to receive user inputs and/or display data. In some embodiments, the generation of the user interface 102 at operation 305 may occur in response to a request for a user interface 102 or other operation (e.g., a request for a financial transaction as described hereafter). By way of example, a first user associated with a first user account may access an application, website, account portal, or the like of, for example, a financial institution. As part of accessing such an application, account portal, or the like, the interface generation circuitry 210 may, in some embodiments, generate an interface (e.g. as shown in FIGS. 4A-4C) in which a user may input a request for a financial transaction.

As described above, in some embodiments, the generation of the user interface at operation 305 may include receiving data from, for example, a second user device 108 associated with a vendor, merchant, broker, or other 3^{rd} party system, device, or service. For example, the transaction server 200 may, via an application programming interface (API) or otherwise, interface with the second user device 108 so as to receive data from the second user device 108 and render, in whole or in part, a portion of the data received from the second user device 108 as the user interface. By way of a particular example, the transaction server 200 may receive data from the second user device 108 necessary to render a website, application, or similar interactive interface as part of the user interface at operation 305.

In some embodiments, such as described hereafter with reference to FIG. 5, the user interface 102 may be generated without a request from the first user or access by a user to an application, website, account portal, or the like. By way of example, the transaction server 200 may operate to determine a deficiency (e.g., lack of sufficient funds to satisfy an upcoming financial obligation or the like) associated with the first user account as described hereafter. In such an embodiment, the generation of the user interface 102 for presentation to the first user at operation 305 may occur responsive to this deficiency determination, and the generated user interface 102 may be transmitted to, for example, the first user device 106 upon this determination. Although described herein with reference to generation of the user interface 102 in response to an action by the first user or in response to a determination by, for example, the interaction circuitry 212, the present disclosure contemplates that the user interface 102 may be generated and maintained by the interface generation circuitry 210 regardless of user interaction. Said differently, the generation of the user interface 102 at operation 305 may occur as part of an initialization procedure such that the user interface 102 may be accessed by any user and associated user device (e.g., the user interface 102 may receive user inputs simultaneously from a plurality of user devices) as part of its normal operation.

In some embodiments, as shown in operation 310, the apparatus (e.g., transaction server 200) includes means, such as input/output circuitry 206, communications circuitry 208, interface generation circuitry 210, or the like, for receiving a user input requesting a financial transaction. As described above, the user interface 102 may be configured to receive one or more user inputs as illustrated in FIGS. 4A-4C. By way of example, the user interface 102 may include a free or open text input that may receive, from the first user, an input that requests a financial transaction (e.g., requests assistance with completing a financial transaction). Although described and illustrated herein with reference to a free text input (e.g., a search bar or the like), the present disclosure contemplates that the generated user interface 102 may allow for any mechanism (e.g., voice inputs, tactile inputs, or the like) for providing a request for a financial transaction. Furthermore, as illustrated in FIGS. 4A-4C, the interaction circuitry 212 may employ natural language processing or other equivalent techniques to identify, and in some embodiments, predict the request for a financial transaction received at operation 310. The request received at operation 310 may, in some embodiments as described herein, relate to a request to purchase an item, a ticket, a vehicle, a house, etc. By way of a particular example as illustrated in FIGS. 4A-4H, the user input requesting a financial transaction may refer to a request for assistance in purchasing a home (e.g., a financial transaction for a home).

As shown in operation 315, the apparatus (e.g., transaction server 200) includes means, such as input/output circuitry 206, interaction circuitry 212, or the like, for accessing first user financial data associated with the first user and the first user account. As described above, first user financial data may refer to a collection of settings, configurations, identifiers, data, and information associated with the first user and associated first user device 106. By way of example, the interaction circuitry 212 may access a database comprising financial data associated with respective users and retrieve first user financial data of a first user that may include account information, preferences, transaction information, account balances, prior transaction histories, investment portfolio data, regular deposit information, and/or the like associated with the first user. In an instance in which the transaction server 200 receives a user input requesting a financial transaction relating to, for example, the purchase of a home, the first user financial data accessed by the interaction circuitry 212 may relate to first user financial data associated with or relevant to the purchase of a home. For example, the interaction circuitry 212 may access first user financial data indicative of the first user's credit score, outstanding debts, income, and/or the like related to securing, for example, a mortgage to purchase a home.

As shown in operation 320, the apparatus (e.g., transaction server 200) includes means, such as input/output circuitry 206, communications circuitry 208, interface generation circuitry 210, or the like, for generating one or more interrogatory objects requesting responsive inputs from the first user based upon the first user financial data and presenting the one or interrogatory objects to the first user in the user interface 102. As described above, the interrogatory objects generated by the interaction circuitry 212 may refer to data configured to be presented to the first user in order to receive or otherwise prompt a user response. For example, the interrogatory objects may be formed as questions requesting particular information of a user and may, in some embodiments, be presented to the user as an open question (e.g., prompting an open text field response). By way of continued example, the first user may input a request for a financial transaction associated with a request for assistance with the purchase of a home. The interaction circuitry 212 may, for example, generate a plurality of interrogatory objects requesting responsive inputs from the first user based upon the accessed first user financial information associated with the purchase of a home.

The accessed first user financial data may, in some embodiments, provide the necessary information to, for example, arrange a financial transaction (e.g., mortgage) to purchase the home. In other embodiments, however, the first user financial data may be incomplete or otherwise insufficient to arrange a financial transaction. Said differently, additional first user financial data may be required from the first user in order to complete (e.g., arrange) the necessary materials for completing the financial transaction. As such, the interaction circuitry 212 may generate and present one or more interrogatory objects to the first user in the user interface 102 in order to obtain the necessary financial information. In some embodiments, the interrogatory objects may be provided in full to the user interface 102 such that the first user may provide responsive inputs to each interrogatory object.

In other embodiments, as shown in FIGS. 4A-4H, the interaction circuitry 212 may present the interrogatory objects to the user device 102 in a conversational manner with the first user. Said differently, the interaction circuitry 212 may present one or several interrogatory objects requesting responsive inputs from the first user and may subsequently present additional interrogatory objects requesting additional responsive inputs from the first user based upon the inputted user responses to the initial one or several interrogatory objects. In this way, the interaction circuitry 212 may reduce the memory and processing burdens experienced by the transaction server 200. For example, if the first user does not intend to finance the purchase of the home (e.g. the requested financial transaction), the interaction circuitry 212 may avoid interrogatory objects directed to receiving first user financial data required for the arranging of a mortgage transaction. As illustrated in FIGS. 4A-4H, the interrogatory objects may also be formed as a statement to which the first user may respond to confirm the information presented in the interrogatory object. Said differently, the interaction circuitry 212 may generate and present interrogatory objects that comprise one or more recommended responsive inputs based upon the first user financial data.

By way of continued example, the interest rate, loan amount, loan term, etc. associated with a mortgage (e.g., requested financial transaction) may vary based upon not only the first user financial data, but also the intent of the first user (e.g., received as responsive inputs or otherwise). Said differently, the first user may qualify for a plurality of mortgages of varying interest rates, terms, etc. As such, the interrogatory objects generated and presented via the user interface 102 may, in some embodiments, provide recommended responsive inputs based upon the interaction circuitry 212's analysis of the first user financial data. For example, the interaction circuitry 212 may analyze the account balances, credit score, transaction history, recurring deposits, and/or the like of the first user as provided by the accessed first user financial data and/or responsive inputs by the first user and provide a recommended responsive input (e.g., a statement for confirmation by the first user).

As shown in operation 325 the apparatus (e.g., transaction server 200) includes means, such as input/output circuitry 206, communications circuitry 208, transaction circuitry 214, or the like, for arranging a financial transaction based upon the first user financial data and one or more responsive inputs by the first user to the interrogatory objects. By way of continued example, the transaction circuitry 214 may, in arranging a financial transaction associated with securing a mortgage for purchasing a home, use first user financial data accessed at operation 315. For example, first user financial data associated with account balances, credit score, etc. may be used to populate necessary documentation, forms, or the like in order to execute the financial transaction as described hereafter. Any information that is outstanding or otherwise missing and necessary to, for example, populate required documentation to complete the financial transaction may be acquired via responsive inputs by the first user to the interrogatory objects as described above. Furthermore, the execution of some financial transactions may, due to applicable industry or governing regulations, require the confirmation (e.g., signature, affirmation, or the like) of the first user before proceeding. In some embodiments, the transaction server may be formed as part of a system of a, for example, financial institution such that the arrangement of the financial transaction may occur in parallel to or simultaneous with the first user's interactions with the user interface 102.

As shown in operation 330 the apparatus (e.g., transaction server 200) includes means, such as input/output circuitry 206, communications circuitry 208, transaction circuitry 214, or the like, for executing the financial transaction within the user interface 102 in response to authorization by the first user. By way of continued example with reference to an example mortgage as the requested financial transaction, the arrangement of the financial transaction (e.g., the completion of the necessary forms, materials, documentation, or the like) at operation 325 may be such that, as part of inclusion in a system of a financial institution, the financial transaction may be executed without further operations by the first user. As described above, various traditional systems often direct a user to various locations, applications, and/or the like in order to perform distinct operations related to a financial transaction. Said differently, these conventional systems fail to provide an integrated system in which a user may request and complete a financial transaction within an user interface.

At operation 330, however, the transaction circuitry 214 may operate to, in some embodiments, request authorization from the first user to proceed with the requested financial transaction and may, in response to authorization from the first user, execute the financial transaction. The execution of this transaction may occur in the user interface 102 in that the requested funds (e.g., the mortgage funds) may be provided to the first user in the user interface 102. Due to the association, in some embodiments, of the first user account and the transaction server 200 with a system of a financial institution, the execution of the requested financial transaction may occur in substantially real-time (e.g., the mortgage funds may be provided to the first user in the user interface 102 in real-time). In some embodiments, as described above, the transaction server 200 may receive data from the second user device 108 and render, in whole or in part, a portion of the data received from the second user device 108 as the user interface. As such, the arrangement of the financial transaction at operation 325 and the subsequent execution of the financial transaction within the user interface at operation 330 may include one or more operations in conjunction with, for example, the second user device 108. Said differently, the execution of the financial transaction at operation 330 may include one or more transmissions between the transaction server 200 and the second user device 108 such that the financial transaction may be executed within the user interface.

As described above, FIGS. 4A-4H illustrate an example user interface 400 during the operations of FIG. 3 with reference to an example mortgage as the requested financial transaction. As shown, the user interface 400 in FIGS. 4A-4C may receive a request for a financial transaction associated with the purchase of a home. As illustrated in FIGS. 4D-4H, various interrogatory objects may be generated based upon the first user financial data and presented to the first user in a conversational manner. As illustrated in FIGS. 4F-4H, the financial transaction (e.g., mortgage) request by the first user is arranged based upon the first user financial data and responsive input(s) by the first user to the interrogatory objects. As shown in FIG. 4H, the financial transaction (e.g., mortgage) is executed within the user interface 400. Although described herein with reference to a requested financial transaction associated with the purchase of home, the present disclosure contemplates that the operations described herein with reference to FIG. 3 may be equally applicable to the purchase of a vehicle, vacation, item, ticker, and/or the like (e.g., any requested financial transaction).

### Example Operations for Task-Related Escrow Disbursement

FIG. 5 illustrates a flowchart containing a series of operations for task-related escrow disbursement. The operations illustrated in FIG. 5 may, for example, be performed by, with the assistance of, and/or under the control of an apparatus (e.g., transaction server 200), as described above. In this regard, performance of the operations may invoke one or more of processor 202, memory 204, input/output circuitry 206, communications circuitry 208, interface generation circuitry 210, interaction circuitry 212, and/or transaction circuitry 214.

As shown in operation 505, the apparatus (e.g., transaction server 200) includes means, such as input/output circuitry 206, communications circuitry 208, interaction circuitry 212, or the like, for querying a financial data database 110 comprising financial data associated with respective users upon generation of the user interface 102. As described above, the transaction server 200 of the present disclosure may also operate proactively to remedy deficiencies associated with a first user's account. As such, at operation 505, the access of first user financial data may occur as part of the generation of the user interface 102 as described above with reference to operation 305. Said differently, the interaction circuitry 212 may access the first user financial data without a request for a financial transaction, or any action, by the first user. As described above, the first user financial data may refer to a collection of settings, configurations, identifiers, data, and information associated with the first user and associated first user device 106. The interaction circuitry 212 may access a database comprising financial data associated with respective users and retrieve first user financial data of a first user that may include account information, preferences, transaction information, account balances, prior transaction histories, investment portfolio data, regular deposit information, and/or the like associated with the first user.

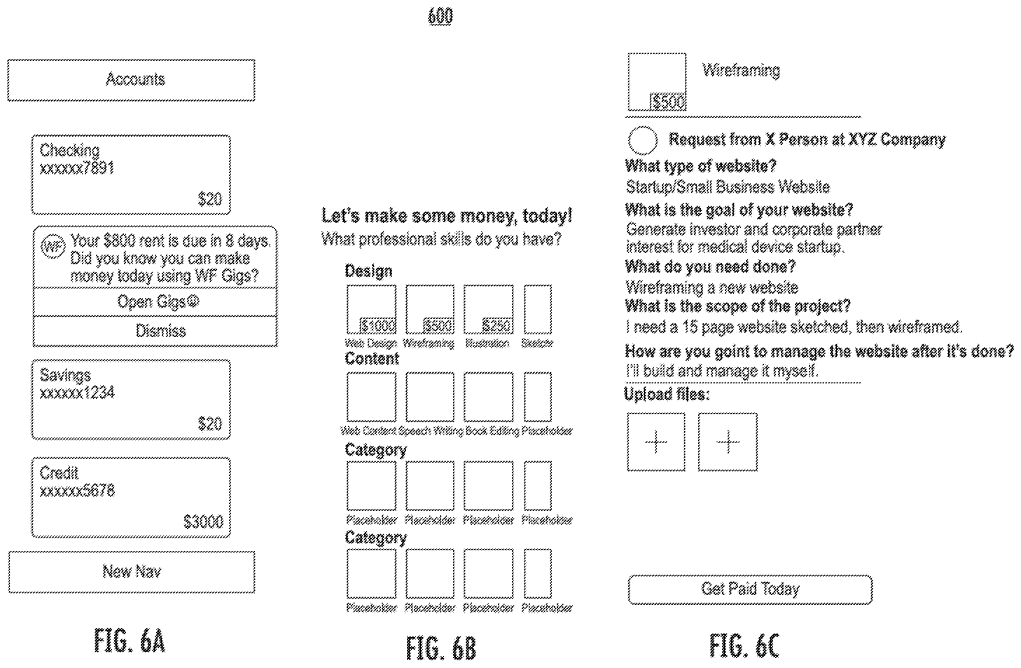

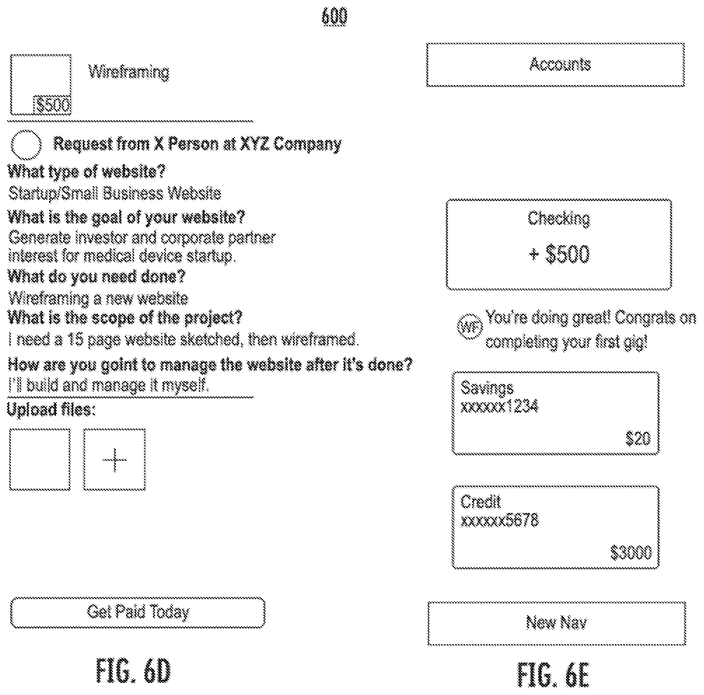

As shown in operation 510, the apparatus (e.g., transaction server 200) includes means, such as input/output circuitry 206, communications circuitry 208, interaction circuitry 212, or the like, for determining at least one instance in which the first user financial data is indicative of a deficiency associated with the first user account. By way of example, the interaction circuitry 212 may, in accessing the first user financial data, determine an insufficient account balance of the first user's account to satisfy an imminent payment as shown in FIG. 6A. Although described hereinafter with reference to an insufficient account balance, the present disclosure contemplates that a deficiency associated with the first user account may refer to any financial situation that may be harmful to the financial wellbeing of the first user (e.g., missed payments, overdraft fees, reduced credit score, etc.).

As shown in operation 515, the apparatus (e.g., transaction server 200) includes means, such as input/output circuitry 206, communications circuitry 208, interaction circuitry 212, or the like, for generating one or more interrogatory objects requesting responsive inputs from the first user comprising project data associated with one or more tasks for completion. In some embodiments, the transaction server 200 may operate to remedy the deficiency in the first user account by providing opportunities to earn funds as illustrated in FIGS. 6B-6C. By way of example, the transaction server 200 may be formed as part of a system of a financial intuition or other entity that may, for example, receive project data from a plurality of users (e.g. second user device 108). The project data received by the transaction server 200 may define one or more tasks that may, when completed, result in payment to the first user as defined by the project data (e.g., from a second user account). By way of a particular example, the interaction circuitry 212 may generate interrogatory objects as described above with reference to operation 320 that May request responsive inputs from the first user. The interrogatory objects may include project data indicative of the one or more tasks associated with the project data (e.g., the project to be completed). As illustrated in FIG. 6B, for example, the interrogatory objects may be presented in the user interface 102 as a collection of selectable objects, each of which is associated with a particular project (e.g. a collection of tasks for completion).

Thereafter, as shown in operation 520, the apparatus (e.g., transaction server 200) includes means, such as input/output circuitry 206, communications circuitry 208, transaction circuitry 214, or the like, for, in an instance in which the responsive input by the first user selects an interrogatory object comprising project data, funding, by a second user account, an escrow account based upon the project data. As described above, the transaction server 200 may be associated with a financial institution that comprises user accounts of a plurality of users (e.g., the second user and associated second user device 108). As such, in an instance in which the first user selects an interrogatory object comprising project data (e.g., submits a responsive input that selects a particular project as defined by the project data of the interrogatory object), the transaction circuitry 214 may transmit funds from a second account of the second user to an escrow account based upon the project data. As described hereafter, the escrow account may store the funds until completion of the tasks defined by the project data. As illustrated in FIGS. 6C-6D, the interrogatory object may comprise project data associated with a wireframing project for completion.

Thereafter, as shown in operation 520, the apparatus (e.g., transaction server 200) includes means, such as input/output circuitry 206, communications circuitry 208, transaction circuitry 214, or the like, for dispersing the funds of the escrow account to the first user account in an instance in which the one or more tasks associated with the project data are complete. As described herein, the interrogatory object with project data may refer to or otherwise indicate a job (e.g., project, gig, work, etc.) that, when completed by the first user, may result in payment to the first user. By way of continued example, the project data and associated tasks may be related to, as shown in FIGS. 6C-6D, a wireframing project that may be undertaken (e.g., via a responsive input to the interrogatory object comprising the respective project data) by the first user. The first user may, for example, complete each of the tasks defined by the project data and may, as shown in FIG. 6E, receive funds defined by the project data deposited into the first user account.

In particular, the transaction circuitry 214 may disperse the funds of the escrow account to the first user account in an instance in which the one or more tasks associated with the project data are complete. In some embodiments, the project data may define one or more verification operations required to ensure completion of the tasks defined by the project data. For example, the transaction circuitry 214 may transmit an actionable notification to the second user device 108 requesting confirmation by the second user of the completion of the tasks defined by the project data. In doing so, the operations of FIG. 5 may serve to proactively identify potential deficiencies associated with an account of a user and provide mechanisms to remedy these deficiencies via earned funds. In some embodiments, the first user account, the second user account, and the transaction server 200 may be formed as part of the system of a financial institution such that the funding of the escrow account and dispersing of funds to the first user account occur in substantially real-time.

As described above, FIGS. 6A-6E illustrate an example user interface 600 during the operations of FIG. 5 with reference to example project data. As shown, the user interface 600 in FIG. 6A may illustrate a potential deficiency in the first user account. As illustrated in FIG. 6B, a plurality of interrogatory objects comprising project data are displayed by the user interface 600. As illustrated in FIGS. 6C-6D, the project data may define one or more tasks for completion in order to receive funds as defined by the respective project data. As shown in FIG. 6E, funds may be dispersed to the first user account upon completion of the one or more tasks associated with the project data. Although described herein with reference to a wireframing project, the present disclosure contemplates that the operations described herein with reference to FIG. 5 may be equally applicable to any task, job, project, work, etc. based upon the intended application of the transaction server 200.

As described above, various technical challenges are surmounted via technical solutions contemplated herein. For instance, example implementations of embodiments of the present disclosure access financial data of a user during interaction with a user interface so as to arrange and execute financial transactions within the user interface. In operation, embodiments of the present disclosure may generate a user interface that may receive user inputs and access financial data associated with a user and associated user account. In order to obtain information regarding the user's intent or request, the disclosed systems may generate interrogatory objects that request responsive inputs from the user and arrange a financial transaction based upon the financial data and responsive inputs of the user. By accessing financial information of a user and, in some embodiments, being formed as part of a system of a financial institution, the systems described herein may execute an authorized financial transaction within the user interface. In this way, the inventor has identified that the advent of new computing technologies have created a new opportunity for solutions for executing financial transactions which were historically unavailable. In doing so, such example implementations confront and solve at least two technical challenges: (1) they generate remedies for user-specific financial deficiencies in real-time, and (2) they minimize processing and computational burdens associated with financial transactions systems.

FIGS. 3 and 5 thus illustrate flowcharts describing the operation of apparatuses, methods, and computer program products according to example embodiments contemplated herein. It will be understood that each flowchart block, and combinations of flowchart blocks, may be implemented by various means, such as hardware, firmware, processor, circuitry, and/or other devices associated with execution of software including one or more computer program instructions. For example, one or more of the operations described above may be implemented by an apparatus executing computer program instructions. In this regard, the computer program instructions may be stored by a memory 204 of the transaction server 200 and executed by a processor 202 of the transaction server 200. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the functions specified in the flowchart blocks. The computer program instructions may also be loaded onto a computer or other programmable apparatus to cause a series of operations to be performed on the computer or other programmable apparatus to produce a computer-implemented process such that the instructions executed on the computer or other programmable apparatus provide operations for implementing the functions specified in the flowchart blocks.

The flowchart blocks support combinations of means for performing the specified functions and combinations of operations for performing the specified functions. It will be understood that one or more blocks of the flowcharts, and combinations of blocks in the flowcharts, can be implemented by special purpose hardware-based computer systems which perform the specified functions, or combinations of special purpose hardware with computer instructions.

### CONCLUSION

Many modifications and other embodiments of the disclosure set forth herein will come to mind to one skilled in the art to which these embodiments pertain having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A computer-implemented method for financial transactions, the computer-implemented method comprising:
generating, by interface generation circuitry, a user interface for presentation to a first user associated with a first user account, the user interface configured to receive one or more user inputs;
causing rendering, via a display of a first user device in real-time, of the user interface;
retrieving, by interaction circuitry from a financial data database, first user financial data associated with the first user and the first user account, wherein the financial data database is located remotely from the first user device;
automatically identifying, by the interaction circuitry and based on the first user financial data, first deficiency data comprising a difference between an insufficient account balance and an imminent payment;
automatically generating, by the interaction circuitry, one or more first interrogatory objects in response to the first user financial data and the first deficiency data, the one or more first interrogatory objects requesting responsive inputs from the first user, wherein at least one of the one or more first interrogatory objects is associated with remedying a deficiency indicated by the first deficiency data by providing the first user with opportunities to earn funds;
causing rendering, via the display of the first user device in real-time, of the one or more first interrogatory objects in the user interface without redirecting to another user interface, application, or website;
receiving, by the interaction circuitry from the first user device, one or more first responsive inputs to the one or more first interrogatory objects, the one or more first responsive inputs associated with remedying the deficiency by the first user earning funds;
identifying, by the interaction circuitry, second user project data associated with a second user and third user project data associated with a third user, wherein the second user project data defines a second user project comprising one or more tasks to perform for the second user and the third user project data defines a third user project comprising one or more tasks to perform for the third user;
automatically generating, by the interaction circuitry, two or more second interrogatory objects, the two or more second interrogatory objects comprising a first project interrogatory object and a second project interrogatory object, the first project interrogatory object generated based on the second user project data and the second project interrogatory object generated based on the third user project data;
causing rendering, via the display of the first user device in real-time, of the two or more second interrogatory objects in the user interface without redirecting to the another user interface, application, or website;
receiving, by the interaction circuitry from the first user device, one or more second responsive inputs in response to presenting the two or more second interrogatory objects, the one or more second responsive inputs including selection of the first project interrogatory object;
causing transfer, in real-time by transaction circuitry and based on the one or more second responsive inputs, of funds from a second user account associated with the second user into an escrow account based on the second user project data;
transmitting, by the transaction circuitry, an actionable notification to a second user device of the second user, the actionable notification requesting confirmation of completion of the second user project;
receiving, by the transaction circuitry from the second user device, confirmation of completion of the second user project; and
causing transfer, by the transaction circuitry in response to the confirmation of completion of the second user project, of the funds from the escrow account to the first user account to remedy the deficiency associated with the first user.

2. The computer-implemented method according to claim 1, wherein accessing the first user financial data further comprises:
receiving a user input via the first user device requesting a financial transaction; and
accessing the first user financial data in response to the user input without redirecting to the another user interface, application, or website.

3. The computer-implemented method according to claim 1, wherein the one or more first interrogatory objects further comprise one or more recommended responsive inputs based upon the first user financial data.

4. The computer-implemented method according to claim 1, wherein accessing the first user financial data further comprises querying a financial data database comprising financial data associated with respective users upon generation of the user interface.

5. (canceled)

6. (canceled)

7. (canceled)

8. An apparatus for financial transactions, the apparatus comprising:
interface generation circuitry configured to:
generate a user interface for presentation to a first user associated with a first user account, the user interface configured to receive one or more user inputs; and
cause render, via a display of a first user device in real-time, of the user interface;
interaction circuitry configured to:
retrieve, from a financial data database, first user financial data associated with the first user and the first user account, wherein the financial data database is located remotely from the first user device;
automatically identify, based on the first user financial data, first deficiency data comprising a difference between an insufficient account balance and an imminent payment;
automatically generate one or more first interrogatory objects in response to the first user financial data and the first deficiency data, the one or more first interrogatory objects requesting responsive inputs from the first user, wherein at least one of the one or more first interrogatory objects is directed to remedying a deficiency indicated by the first deficiency data by providing the first user with opportunities to earn funds;
cause rendering, via the display of the first user device in real-time, of the one or more first interrogatory objects in the user interface without redirecting to another user interface, application, or website;
receive, from the first user device, one or more first responsive inputs to the one or more first interrogatory objects, the one or more first responsive inputs associated with remedying the deficiency by the first user earning funds;
identify second user project data associated with a second user and third user project data associated with a third user, wherein the second user project data defines a second user project comprising one or more tasks to perform for the second user and the third user project data defines a third user project comprising one or more tasks to perform for the third user;
automatically generate two or more second interrogatory objects, the two or more second interrogatory objects comprising a first project interrogatory object and a second project interrogatory object, the first project interrogatory object generated based on the second user project data and the second project interrogatory object generated based on the third user project data;
cause rendering, via the display of the first user device in real-time, of the two or more second interrogatory objects in the user interface without redirecting to the another user interface, application, or website; and
receive, from the first user device, one or more second responsive inputs to the two or more second interrogatory objects, the one or more second responsive inputs including selection of the first project interrogatory object; and
transaction circuitry configured to:
cause transfer, in real-time based on the one or more second responsive inputs-, of funds from a second user account associated with the second user into an escrow account based on the second user project data;
transmit an actionable notification to a second user device of the second user, the actionable notification requesting confirmation of completion of the second user project;
receive, from the second user device, a confirmation of completion of the second user project; and
cause transfer, in response to the confirmation of completion of the second user project, of the funds from the escrow account to the first user account to remedy the deficiency associated with the first user.

9. The apparatus according to claim 8, wherein the interaction circuitry is further configured to:
receive a user input via the first user device requesting a financial transaction; and
access the first user financial data in response to the user input without redirecting to the another user interface, application, or website.

10. The apparatus according to claim 8, wherein the one or more first interrogatory objects further comprise one or more recommended responsive inputs based upon the first user financial data.

11. The apparatus according to claim 8, wherein the interaction circuitry is further configured to query a financial data database comprising financial data associated with respective users upon generation of the user interface.

12. (canceled)

13. (canceled)

14. (canceled)

15. A non-transitory computer-readable storage medium for financial transactions, the non-transitory computer-readable storage medium storing instructions that, when executed, cause an apparatus to:
generate, by interface generation circuitry, a user interface for presentation to a first user associated with a first user account, the user interface configured to receive one or more user inputs;
cause rendering, via a display of a first user device in real-time, of the user interface;
retrieve, by interaction circuitry from a financial data database, first user financial data associated with the first user and the first user account, wherein the financial data database is located remotely from the first user device;
automatically identify, by the interaction circuitry and based on the first user financial data, first deficiency data comprising a difference between an insufficient account balance and an imminent payment;
automatically generate, by the interaction circuitry, one or more first interrogatory objects in response to the first user financial data and the first deficiency data, the one or more first interrogatory objects requesting responsive inputs from the first user, wherein at least one of the one or more first interrogatory objects is directed to remedying a deficiency indicated by the first deficiency data by providing the first user with opportunities to earn funds;
cause rendering, via the display of the first user device in real-time, of the one or more first interrogatory objects in the user interface without redirecting to another user interface, application, or website;
receive, by the interaction circuitry from the first user device, one or more first responsive inputs to the one or more first interrogatory objects, the one or more first responsive inputs associated with remedying the deficiency by the first user earning funds;
identify, by the interaction circuitry, second user project data associated with a second user and third user project data associated with a third user, wherein the second user project data defines a second user project comprising one or more tasks to perform for the second user and the third user project data defines a third user project comprising one or more tasks to perform for the third user;
automatically generate, by the interaction circuitry, two or more second interrogatory objects, the two or more second interrogatory objects comprising a first project interrogatory object and a second project interrogatory object, the first project interrogatory object generated based on the second user project data and the second project interrogatory object generated based on the third user project data;
cause rendering, via the display of the first user device in real-time, of the two or more second interrogatory objects in the user interface without redirecting to the another user interface, application, or website;
receive, by the interaction circuitry from the first user device, one or more second responsive inputs to the two or more second interrogatory objects, the one or more second responsive inputs including selection of the first project interrogatory object;
cause transfer, in real-time by transaction circuitry and based on the one or more second responsive inputs, of funds from a second user account associated with the second user into an escrow account based on the second user project data;
transmit, by the transaction circuitry, an actionable notification to a second user device of the second user, the actionable notification requesting confirmation of completion of the second user project;
receive, by the transaction circuitry from the second user device, a confirmation of completion of the second user project; and
cause transfer, by the transaction circuitry in response to the confirmation of completion of the second user project, of the funds from the escrow account to the first user account to remedy the deficiency associated with the first user.

16. The non-transitory computer-readable storage medium according to claim 15 storing instruction that, when executed, cause the apparatus to:
receive a user input via the first user device requesting a financial transaction; and
access the first user financial data in response to the user input without redirecting to the another user interface, application, or website.

17. The non-transitory computer-readable storage medium according to claim 15, wherein the one or more first interrogatory objects further comprise one or more recommended responsive inputs based upon the first user financial data.

18. The non-transitory computer-readable storage medium according to claim 15 storing instruction that, when executed, cause the apparatus to query a financial data database comprising financial data associated with respective users upon generation of the user interface.

19. (canceled)

20. (canceled)

21. The computer-implemented method according to claim 1, wherein the second user project data defines one or more verification operations required to ensure completion of the one or more tasks defined by the second user project data.

22. The computer-implemented method according to claim 1, comprising receiving the second user project data from the second user device.

23. The computer-implemented method according to claim 1, wherein the two or more second interrogatory objects are grouped by category when presented in the user interface via the first user device.

24. The apparatus according to claim 8, wherein the second user project data defines one or more verification operations required to ensure completion of the one or more tasks defined by the second user project data.

25. The apparatus according to claim 8, wherein the interaction circuitry is further configured to receive the second user project data from the second user device.

26. The apparatus according to claim 8, wherein the interaction circuitry is further configured to form at least one of the two or more second interrogatory objects are formed as a statement requesting a confirmation.

27. The non-transitory computer-readable storage medium according to claim 15, wherein the second user project data defines one or more verification operations required to ensure completion of the one or more tasks defined by the second user project data.

28. The non-transitory computer-readable storage medium according to claim 15 storing instruction that, when executed, cause the apparatus to receive the second user project data from the second user device.
